(19) United States
(12) Patent Application Publication
(10) Pub. No.: US 2026/0208105 A1
(43) Pub. Date: Jul. 23, 2026

(54) AMMONIA OXIDATION CATALYST WITH ZONED SCR INLET AND PGM OUTLET FOR GASOLINE APPLICATIONS

(71) Applicants: BASF CORPORATION, Florham Park, NJ (US); BASF SE, FLORHAM PARK, NJ (US)

(72) Inventors: Karifala DUMBUYA, Hannover (DE); Markus KINNE, Hannover (DE); Holger SCHWEKENDIEK, Hannover (DE); Thomas SCHMITZ, Hannover (DE)

(21) Appl. No.: 19/140,212

(22) PCT Filed: Dec. 19, 2023
(86) PCT No.: PCT/EP2023/086696

§ 371 Date: Jun. 17, 2025

(30) Foreign Application Priority Data
Dec. 21, 2022 (EP) 22215373.6

(51) Int. Cl. B01D 53/94; B01J 23/63; B01J 29/76; B01J 35/00; B01J 35/57; B01J 37/02; B01J 37/08; B01J 37/30; F01N 3/022; F01N 3/10; F01N 3/20; F01N 3/28

(52) U.S. Cl. CPC B01D 53/9436; B01D 53/9418; B01D 53/945; B01D 53/9472; B01D 53/9477; B01J 23/63; B01J 29/763; B01J 35/19; B01J 35/57; B01J 37/0205; B01J 37/08; B01J 37/30; F01N 3/022; F01N 3/101; F01N 3/106; F01N 3/2066; F01N 3/2803; B01D 2255/1021; B01D 2255/1023; B01D 2255/1025; B01D 2255/20707; B01D 2255/2073; B01D 2255/20738; B01D 2255/20761; B01D 2255/50; B01D 2255/9032; B01D 2255/9155; B01D 2257/406; B01D 2258/012; B01J 2229/186; F01N 2370/04; F01N 2510/063; F01N 2510/068; F01N 2610/02

(57) ABSTRACT

The present invention relates to an exhaust gas treatment system for reducing ammonia emission from a gasoline engine comprising a three-way conversion catalyst (TWC) and a gasoline particulate filter (GPF) further comprising a catalytic function for reducing tailpipe emission of ammonia wherein the catalytic function for reducing tailpipe emission of ammonia includes at least a combination of a selective catalytic reduction catalyst (SCR) and an ammonia oxidation catalyst (AM Ox). The present invention also relates to a method for preparing the exhaust gas treatment system and a method for treating an exhaust gas stream from a gasoline engine using the inventive exhaust gas treatment system.

The present invention relates to the field of exhaust gas treatment systems for automotive applications, especially exhaust gas treatments systems suitable for gasoline engines. The present invention especially relates to catalysts and methods for removing ammonia emission from exhaust gas streams generated from gasoline engines.

EURO 6 regulation requires removal of nitrogen oxides (NOx), unburned hydrocarbons (HC) and carbon monoxide (CO) from the exhaust gas stream of automotive engines. In addition, reduction of particle emission needs to be achieved as well.

These requirements have been met by the introduction of three-way conversion catalysts (TWC) that have been effective in removing nitrogen oxides, hydrocarbons and carbon monoxide, while three-way conversion catalysts (TWC) optionally combined with a filter function e.g. four-way conversion catalysts (FWC) have been further developed for effective removal of particulates.

In consequence, three-way conversion catalysts (TWC) and four-way conversion catalysts (FWC) have found wide-spread use in the treatment of exhaust gas streams generated in the automotive field. This applies to exhaust gas streams obtained from diesel engines as well as gasoline engines.

However, the political effort towards climate neutrality based on European Green Deal's zero pollution ambition will further progress emission regulations. The even stricter EURO 7 emission standard is currently in the making, which will require further evolution of exhaust gas treatment systems in the automotive field For instance, ammonia (NH₃) removal from tailpipe emissions will become another mandatory requirement for exhaust gas treatment system in the near future.

In this regard, one unsolved problem of currently used exhaust gas treatment lines arises from the potential “ammonia slip” from SCR catalysts in which ammonia injection is used for purging NOx. In addition, even in exhaust gas treatment systems without ammonia injection systems, ammonia can be formed in the exhaust gas of gasoline engines via several routes when hydrogen gas reacts with several nitrogen oxides to form ammonia. Hydrogen is generated over precious metal sites during the so-called water gas shift reaction facilitated by periodic exhaust handling as is the case in gasoline applications. The pathway includes the reaction from carbon monoxide and water vapor and/or by steam reforming at temperatures higher than 350° C., when hydrocarbons react with water to form hydrogen. For instance, nitric oxide (NO) and nitrogen dioxide (NO₂) can react in the presence of hydrogen to generate ammonia.

The amount of ammonia formed in exhaust gas can depend on engine calibration and catalyst composition. The effective concentrations of carbon monoxide and hydrogen in the exhaust stream, the duration of rich transient conditions, air/fuel ratio, temperature and space velocity are all factors, which can contribute to the formation of ammonia. Further, the interaction of the platinum group metals (PGM) and the oxygen storage component (OSC) may also impact hydrogen formation in the water gas shift reaction.

Accordingly, based on the expected future EURO 7 regulations and the conventional, presently used three-way conversion catalysts (TWC) with filter function, there is a need for complementing the already existing exhaust gas treatment systems with an additional ammonia purging function for significantly reducing ammonia tailpipe emissions of automotives in the future.

An additional important objective is to establish a good balance in the traditional three-way conversion catalysts having particulate filter function in the presence of an additional ammonia removal functionality for achieving a concerted removal of all relevant pollutants including nitrogen oxides (NOx), unburned hydrocarbons (HC), carbon monoxide (CO), particulates and ammonia (NH₃).

One additional objective of the catalytic configurations is the stability of the exhaust treatment systems over time during prolonged operation at high temperatures usually observed in gasoline engines with their alternating lean/rich cycles and relatively high engine temperatures. Therefore, aging stability during extended operation at high engine temperatures is a critical requirement for any catalytic configuration to be used in exhaust gas treatment systems for gasoline engines. One further objective is to achieve the removal of the relevant pollutants with a catalytic configuration that only applies all the necessary catalytic function in not more than the absolutely required amounts. Most catalytic functions include expensive components like platinum group metals or zeolites requiring laborious preparations leading to the challenge of using only limited amounts of such precious components in the relevant catalysts.

These objectives are solved by the first aspect of the present invention, which is an exhaust gas treatment system for reducing ammonia emission from a gasoline engine comprising a three-way conversion catalyst (TWC) and a gasoline particulate filter (GPF) further comprising a catalytic function for reducing tailpipe emission of ammonia characterized in that the catalytic function for reducing tailpipe emission of ammonia includes at least a combination of a selective catalytic reduction catalyst (SCR) and an ammonia oxidation catalyst (AMOx).

In a preferred embodiment, the three-way conversion catalyst (TWC) comprises a first three-way conversion catalyst (TWC) followed by a gasoline particulate filter (GPF) coated with a second three-way conversion catalyst (TWC).

In another preferred embodiment, the three-way conversion catalyst and the gasoline particulate filter (GPF) are positioned upstream of the exhaust gas treatment system in close-coupled (CC) position to the gasoline engine.

In another preferred embodiment, the selective catalytic reduction catalyst (SCR) and the ammonia oxidation catalyst (AMOx) are combined on a substrate in one single layer.

In another preferred embodiment, the ammonia oxidation catalyst (AMOx) comprises at least one catalytic metal on an alumina substrate.

In another preferred embodiment, the ammonia oxidation catalyst (AMOx) comprises at least rhodium on a zirconia-doped alumina support, preferably rhodium in combination with platinum and/or palladium on an alumina support.

In another preferred embodiment, the ammonia oxidation catalyst (AMOx) does not comprise any rhodium.

In another preferred embodiment, the ammonia oxidation catalyst (AMOx) comprises titanium and/or manganese, preferably in combination with platinum and/or palladium, on an alumina support.

In another preferred embodiment, the selective catalytic reduction catalyst (SCR) comprises a metal-promoted, preferably copper-or iron-promoted zeolite, more preferably a copper-or iron-promoted chabazite zeolite.

In another preferred embodiment, the ammonia oxidation catalyst (AMOx) comprises a three-way conversion catalyst (TWC) including at least one platinum group metal, an oxygen storage component (OSC), preferably comprising ceria-zirconia, and optionally a promoter, preferably comprising baria.

In another preferred embodiment, the catalytic function for reducing tailpipe emission of ammonia including at least the combination of the selective catalytic reduction catalyst (SCR) and the ammonia oxidation catalyst (AMOx) is a zoned catalytic function defined by the selective catalytic reduction catalyst (SCR) comprising the metal-promoted zeolite being washcoated at the inlet zone of the catalytic function for reducing tailpipe emission of ammonia, and the ammonia oxidation catalyst (AMOx), preferably comprising a three-way conversion (TWC) catalyst, being washcoated at the outlet zone of the catalytic function for reducing tailpipe emission of ammonia.

In another preferred embodiment, the washcoat comprising the ammonia oxidation catalyst (AMOx), preferably comprising the additional three-way conversion catalyst (TWC), is prepared from a slurry comprising the at least one platinum group metal on a support without the step of thermally fixating the platinum group metal on the support.

In the second aspect of the present invention, a method is provided for the preparation of the exhaust gas treatment system comprising the steps of
providing a three-way conversion catalyst (TWC) and a gasoline partoculate filter (GPF),
preparing a first slurry comprising the ammonia oxidation catalyst (AMOx) by impregnating at least one catalytically active metal on an alumina support,
preparing a second slurry comprising the selective catalytic reduction catalyst (SCR) comprising a metal-promoted zeolite,
blending the first slurry and the second slurry to obtain a combined slurry comprising the ammonia oxidation catalyst (AMOx) from the first slurry and the selective catalytic reduction catalyst (SCR) from the second slurry,
impregnating a support with the combined slurry to obtain the catalytic function for reducing the tailpipe emission of ammonia comprising the ammonia oxidation catalyst (AMOx) and the selective catalytic reduction catalyst (SCR) combined in a single layer on the support, and
positioning the catalytic function for reducing the tailpipe emission of ammonia comprising the ammonia oxidation catalyst (AMOx) and the selective catalytic reduction catalyst (SCR) downstream to the three-way conversion catalyst (TWC) and the gasoline particulate filter (GPF).

In a preferred embodiment, the second slurry comprising the selective catalytic reduction catalyst (SCR) is prepared by providing a slurry comprising a zeolite, which is not metal-promoted or metal-promoted, and carrying out metal exchange of the zeolite by ion exchange in the slurry to obtain the second slurry comprising the selective catalytic reduction catalyst (SCR) comprising the metal-promoted zeolite.

In the third aspect of the present invention, a method is provided for treating an exhaust gas stream of a gasoline engine comprising the steps of providing an exhaust gas stream from a gasoline engine comprising ammonia, and contacting the exhaust gas stream comprising ammonia with the exhaust gas treatment system according to the present invention to reduce the ammonia emission in the exhaust gas stream.

### BRIEF DESCRIPTION OF DRAWINGS

FIG. 1 illustrates the various configurations of the catalysts in an exhaust gas system for gasoline engines.

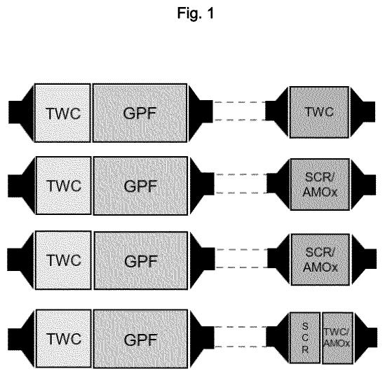

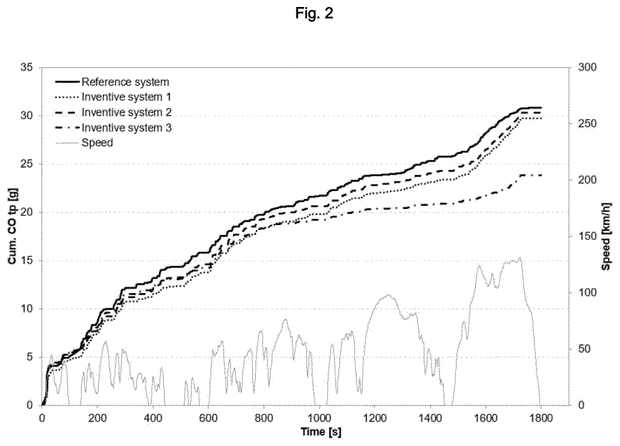

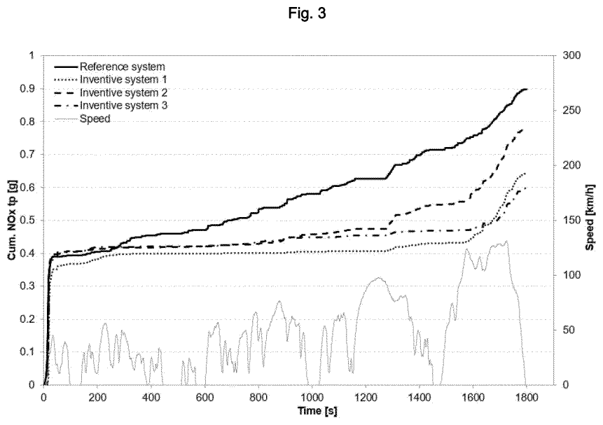

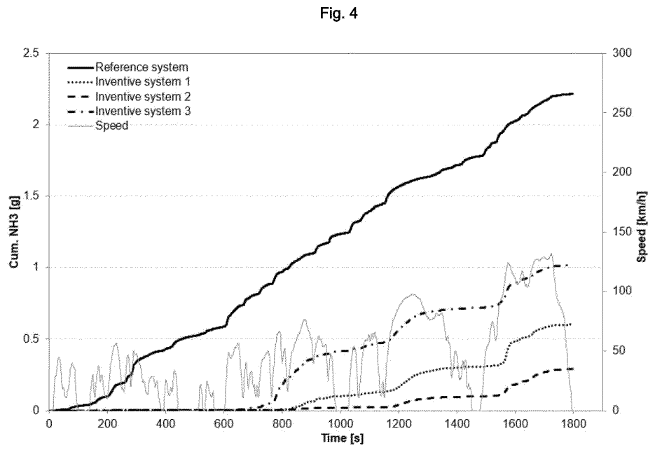

The first configuration shown in FIG. 1 is a comparative reference system and comprises the usual TWC function herein combined with a gasoline particulate filter (GPF) located upstream and followed downstream by another TWC catalyst in underfloor position, which is largely insufficient to purge ammonia in significant amounts. The following three configurations in FIG. 1 are according to the present invention and include again the usual TWC function herein combined with a gasoline particulate filter (GPF) located upstream followed by three different, inventive SCR/AMOx functions located downstream of the TWC/GPF function. The catalysts in the four configurations have been oven aged under specific gas composition at an interior oven temperature of 820° C. for 15 hours.

The second and the third configuration in FIG. 1 (the first and second inventive configuration, like in inventive example 1 and 2, respectively) can have several differences: In the second configuration (the first invention configuration), the platinum group metals and the zeolite are used in one slurry to obtain a single slurry, single layer design with respect to the SCR/AMOx function. In the third configuration, the second inventive configuration, platinum group metals and the zeolite can be applied on the same ceramic honeycomb flowthrough substrate under the same preparation conditions in one slurry to obtain a single slurry, single layer design on the substrate, albeit preferably with slightly different amount of total wash coat. Further, in contrast to the second configuration (the first inventive configuration), the third configuration (the second inventive configuration) can be derived from a different zeolite slurry process obtained from a so-called “in-slurry-ion-exchange” approach, in which Cu-exchange is carried out during the slurry process. Another difference in the third configuration of FIG. 1 (the second inventive configuration) can be that the platinum group metal rhodium (Rh) is replaced by titanium (Ti) and manganese (Mn).

The fourth configuration in FIG. 1 (the third inventive configuration, like in inventive example 3) differs from all other configurations by following up the usual TWC/GPF function located upstream with a SCR/AMOx function for removal of ammonia that is arranged in a zoned configuration leading to a presentation of the SCR and the TWC/AMOx catalytic function on separate locations of the ceramic honeycomb flowthrough substrates downstream of the TWC/GPF function.

FIG. 2 is a diagram showing the tailpipe emission of carbon monoxide (CO) observed in the four configurations as described in FIG. 1 over time. In the diagram of FIG. 2, the speed applied in the Euro 6 GTDI vehicle with a chassis dyno test cell is also shown for further comparison of the four catalytic configurations.

FIG. 3 is a diagram showing the tailpipe emission of nitrogen oxides (NOx) observed in the four configurations as described in FIG. 1 over time. In the diagram of FIG. 3, the speed applied in the Euro 6 GTDI vehicle with a chassis dyno test cell is also shown for further comparison of the four catalytic configurations.

FIG. 4 is a diagram showing the tailpipe emission of ammonia (NH3) observed in the four configurations as described in FIG. 1 over time. In the diagram of FIG. 4, the speed applied in the Euro 6 GTDI vehicle with a chassis dyno test cell is also shown for further comparison of the four catalytic configurations.

In the following, the exhaust gas treatment system of the present invention is described in more detail.

As used herein, the terms “catalyst”, “catalytic function”, “catalyst component”, “catalyst material” or the like refer to a material that promotes a reaction or several reactions. Accordingly, the present invention is generally characterized by combining several catalytic functions in one exhaust gas treatment line for synergistically removing several pollutants from the tailpipe at the same time.

The individual catalytic functions of the exhaust gas treatment system for reducing ammonia emission from a gasoline engine according to the present invention are defined below in greater detail:

The exhaust gas treatment system according to the present invention comprises a three-way conversion catalyst (TWC) downstream to the gasoline engine. The three-way conversion catalyst (TWC) is preferably positioned in close proximity to the gasoline engine, typically in close-coupled position. More preferably, there is no other catalytic function positioned between the outlet of the gasoline engine and the three-way conversion catalyst (TWC) and the three-way conversion catalyst (TWC) is the first catalytic function of the inventive exhaust gas treatment system located after the outlet of the gasoline engine.

The terms “upstream” and “downstream” as used in the present invention have its ordinary meaning in the art, and are therefore also used herein to generally denote the relative position of a catalytic function or component when compared to the relative position of another catalytic function or component (or the gasoline engine) in the exhaust gas system based on the flow direction of the exhaust gas stream.

The term “close-coupled” indicates a position, which is located in fluid communication with and shortly downstream the engine outlet, preferably the gasoline engine outlet, preferably within 50 cm, more preferably within 30 cm and most preferably within 20 cm after the engine outlet. Therefore, in the context of the present invention, a “close-coupled” position is understood as it is commonly understood in the art, which is for instance substantially closer to the engine than in traditional “underfloor” positions (which are beneath the floor of a vehicle). Generally, al-though not limited thereto, such a “close-coupled” position is preferably within the engine compartment, which is normally beneath the hood of a vehicle, and adjacent to the exhaust manifold.

Therefore, the three-way conversion catalyst (TWC) positioned in “close-coupled” position is commonly exposed to high temperature exhaust gas immediately exiting the engine after the engine has warmed up, and thus often serves to reduce hydrocarbon emissions during cold start, which is typically the period immediately following the start of the engine from ambient conditions.

In the following, the three-way conversion catalyst of the present invention is described in more detail.

In the most generic embodiment, the three-way conversion catalyst (TWC) is not particularly limited but needs to provide the common essential components of a three-way conversion catalyst (TWC) suitable for removing the three major pollutants arising from gasoline engines including unburned hydrocarbons (HC), nitrogen oxides (NOx) and carbon monoxide (CO).

Accordingly, the composition of the three-way conversion catalytic coating is selected to comprise a hydrocarbon (HC) oxidation component, a carbon monoxide (CO) oxidation component, and a nitrogen oxide (NOx) reduction component allowing to purge NOx, HC and CO from the exhaust gas stream of the gasoline stream.

The three-way conversion catalyst (TWC) of the present invention includes a platinum group metal (PGM) component, i.e. at least one platinum group metal. The platinum group metal (PGM) component is combined in the catalyst with a suitable support material, typically a refractory metal oxide support. The combination of the at least one platinum group metal (PGM) and the refractory metal oxide support can be important for achieving high catalyst performance and excellent stability in view of aging at high temperatures over prolonged times.

The whole three-way conversion catalyst (TWC) is positioned on a suitable carrier material that allows positioning the three-way conversion catalyst (TWC) in the exhaust gas treatment line of an automotive in the most appropriate manner. The carrier material is defined in more detail below.

Accordingly, a preferred three-way conversion catalyst (TWC) of the present invention for the treatment of an exhaust gas stream comprising nitrogen oxides (NOx), carbon monoxide (CO) and hydrocarbons (HC), comprises at least one platinum group metal (PGM), a refractory metal oxide support, and a carrier characterized in that the platinum group metal (PGM) preferably comprises at least one platinum group metal selected from platinum, palladium and rhodium. One preferred combination of the at least one platinum group metal is palladium and rhodium, or alternatively, platinum and rhodium, or alternatively, a combination of the three platinum group metals platinum, palladium, and rhodium, or alternatively, even only platinum and palladium.

Further, additional platinum group metals (PGM) other than platinum, palladium and rhodium can be optionally present as well. For instance, further platinum group metals (PGM) like ruthenium, osmium and/or iridium can be optionally present in the three-way conversion catalyst (TWC) of the present invention.

If the at least one platinum group metal in the three-way conversion catalyst comprises platinum and palladium, the weight ratio of platinum to palladium in the three-way conversion catalyst (TWC), based on the total weight of the platinum group metals (PGM), is preferably from 5:95 to 45:55, and the refractory metal oxide support is preferably selected from a mixture or mixed oxide of ceria and alumina or lanthana-doped alumina comprising lanthana in an amount of up to 10 wt % based on the weight of the lanthana-doped alumina, wherein, more preferably, such three-way conversion catalyst (TWC) is in close-coupled position to the engine outlet.

Even more preferably, the three-way conversion catalyst (TWC) is located in fluid communication with and shortly downstream the engine outlet, preferably the gasoline engine outlet. Most preferably, the three-way conversion catalyst (TWC) of the present invention is located within 50 cm, more preferably within 30 cm and most preferably within 20 cm after the engine outlet. It is also especially preferred that the three-way conversion catalyst (TWC) is not in under-floor position, i.e. beneath the floor of a vehicle.

In other words, the three-way conversion catalyst (TWC) is in close-coupled position within the engine compartment, preferably beneath the hood of a vehicle and adjacent to the exhaust manifold. Therefore, a three-way conversion catalyst (TWC) positioned in “close-coupled” position is commonly exposed to high temperature exhaust gas immediately exiting the engine after the engine has warmed up, and thus often serves to reduce hydrocarbon emissions during cold start, which is typically the period immediately following the start of the engine from ambient conditions.

The total loading of the platinum group metal (PGM) component supported on the refractory metal oxide support in the three-way conversion catalyst (TWC) of the present invention can preferably be in the range of from 1 to 200 g/ft³, more preferably in the range of from 20 to 180 g/ft³, even more preferably in the range of from 50 to 150 g/ft³, and most preferably in the range of from 70 to 125 g/ft³. Generally, the skilled person will be familiar with determining the loadings of platinum group metals (PGM) on catalytic coatings. For instance, XRF (X-ray fluorescence) and inductively coupled plasma atomic emission spectroscopy (ICP-AES) can be used for measuring the catalytic loading of platinum group metal (PGM).

The three-way conversion catalyst (TWC) of the present invention comprises a refractory metal oxide support. The refractory metal oxide support is essential to the present invention and is combined with the platinum group metal (PGM) component in the inventive catalyst. Preferably, the refractory metal oxide support is non-zeolithic.

One preferred refractory metal support material comprises a mixture or mixed oxide of cerium oxide and aluminum oxide. Preferably, the mixture or the mixed oxide of cerium oxide to aluminum oxide has a weight ratio of ceria to alumina from 10:90 to 90:10, or 25:75 to 75:25, or 30:70 to 70:30, more preferably from 40:60 to 60:40, and even more preferably from 45:55 to 55:45.

Another preferred refractory metal support material is alumina, especially high porosity alumina. Especially preferred can be aluminum oxide that is doped with lanthana (like La₂O₃). Alumina doped with lanthana refers to alumina containing a rather small amount of lanthana, preferably up to 10 wt %, more preferably up to 7 wt %, even more preferably up to 5 wt %, and most preferably up to 4 wt % lanthana based on the weight of the lanthana-doped alumina. The La-doped alumina (L-doped alumina) contains at least 0.5 wt %, more preferably at least 1 wt %, and most preferably at least 2 wt % lanthana, based on the weight of the lanthana-doped alumina.

The aluminum oxide as used in the inventive refractory metal oxide support material can be preferably stabilized aluminum oxide. The aluminum oxide of the refractory metal oxide support can also preferably be gamma aluminum oxide. The refractory metal oxide support of the three-way conversion catalyst (TWC) of the present invention can optionally comprise additional metal oxides, like zirconia, ceria, baria and/or neodymia.

The total loading of the refractory metal oxide support in the three-way conversion catalyst (TWC) of the present invention is preferably in the range of from 0.2 to 6.0 g/in³, more preferably in the range of from 0.5 to 5.0 g/in³, more preferably in the range of from 1.0 to 4.0 g/in³, and even more preferably in the range of from 2.5 to 3.5 g/in³.

The ceria content in the three-way conversion catalyst (TWC) of the present invention preferably is in the range of 0.4 to 4.0 g/in³, more preferably in the range of 0.7 to 3.0 g/in³, even more preferably in the range of 0.9 to 2.0 g/in³, or most preferably in the range of 1.0 to 1.5 g/in³.

More preferably, the refractory metal oxide support has a porosity in the range of from 0.05 to 1.5 ml/g, more preferably in the range of from 0.1 to 1.0 ml/g, more preferably in the range of from 0.15 to 0.8 ml/g. The porosity of the refractory metal oxide support is determined by physisorption of N2 and analyzing the physisorption isotherms via BJH (Barett, Joyner, Halenda) analysis according to DIN 66134.

The three-way conversion catalyst (TWC) preferably includes an additional oxygen storage component (OSC) and/or a promoter component. The skilled person will understand the technical role the additional oxygen storage component (OSC) and/or the promoter component generally play in the three-way conversion catalyst.

The three-way conversion catalyst (TWC) of the present invention preferably includes an additional oxygen storage compound. Such an oxygen storage compound can be present in a bottom washcoat or in a top washcoat, or in the bottom and top washcoat, when several washcoats are applied in the three-way conversion catalyst (TWC) of the present invention.

More preferably, the oxygen storage compound comprises cerium, even more preferably comprises one or more of a cerium oxide, a mixture of oxides comprising a cerium oxide, and a mixed oxide comprising cerium, wherein the mixed oxide comprising cerium preferably additionally comprises one or more of zirconium, yttrium, neodynium, lanthanum, and praseodymium, more preferably additionally comprises one or more of zirconium, yttrium, neodynium, and lanthanum, more preferably additionally comprises zirconium, yttrium, neodynium, and lanthanum. Further, the oxygen storage compound comprising cerium may consist of two or more different mixed oxides wherein each one of these mixed oxides may comprise cerium and one or more of zirconium, yttrium, neodynium, lanthanum, and praseodymium. The mixture or mixed oxide of cerium oxide and zirconium oxide is one especially preferred oxygen storage component.

The oxygen storage compound has a preferred porosity in the range of from 0.05 to 1.5 ml/g, more preferably in the range of from 0.1 to 1.0 ml/g, more preferably in the range of from 0.15 to 0.8 ml/g. The porosity of the oxygen storage compound is determined by physisorption of N₂ and analyzing the physisorption isotherms via BJH (Barett, Joyner, Halenda) analysis according to DIN 66134.

The three-way conversion catalyst (TWC) preferably comprises an additional promoter component. The term “promoter” as used in the context of the present invention relates to a compound, which enhances the overall catalytic activity and/or contributes to the stability of the three-way conversion catalyst.

If the three-way conversion catalyst (TWC) of the present invention is a layered catalyst comprising several coatings, i.e. several washcoats, for example including a bottom washcoat and a top washcoat, a promoter component can be preferably included in either the bottom washcoat or the top washcoat, or even more preferably in both the bottom washcoat as well as the top washcoat. The promoter component preferably comprises one or more of zirconium, barium, strontium, lanthanum, neodymium, yttrium, and praseodymium, like for instance barium or zirconia. One preferred promoter component is defined by the mixture of barium, zirconium and neodymium, or a mixed oxide of barium, zirconium and neodymium. If a ternary mixture of barium oxide, zirconium oxide and neodymium oxide is used as promoter component, the weight ratio of barium oxide to zirconium oxide to neodymium oxide is preferably from 2:1:1 to 7:1:1, more preferably from 3:1:1 to 6:1:1, and even more preferably from 4:1:1 to 5:1:1. Another preferred promoter component comprises one or more of zirconium and barium. In one embodiment, the promoter comprises, more preferably is, one or more of a mixture of barium oxide and strontium oxide and a mixed oxide of barium and strontium. Another very preferred promoter is the mixture of barium oxide and zirconium oxide, or alternatively, either barium oxide or zirconium oxide. If a mixture of barium oxide and zirconium oxide is used as promoter component, the weight ratio of barium oxide to zirconium oxide is preferably from 0.5 to 5, more preferably from 1 to 3, even more preferably from 1.2 to 2.5. A preferred amount of promoter component in the three-way conversion catalyst (TWC) of the present invention, or in one of the washcoats, like the bottom or the top washcoat, is defined by a loading in the range of from 0.01 to 0.5 g/in³, more preferably from 0.02 to 0.25 g/in³, or even more preferably in the range of from 0.05 to 0.12 g/in³.

It is preferred in the present invention that the three-way conversion catalyst has a layered design. That is, the three-way conversion catalyst of the present invention is preferably prepared by applying the various catalytic functions or catalytic components to the carrier in the form of coating or several coatings (commonly referred to as washcoat or washcoats).

As used herein and as described in Heck, Ronald and Robert Farrauto, Catalytic Air Pollution Control, New York: Wiley-Interscience, 2002, pp. 18-19, a washcoat layer comprises a compositionally distinct layer of material disposed on the surface of a monolithic substrate or optionally on an underlying washcoat layer. A washcoat typically is comprised of a refractory metal oxide support having high surface area and further catalytically active materials including platinum group metal (PGM), and optionally further materials like oxygen storage components and/or promoters. Preferably, additives like binders can also be included.

Preferably, the three-way conversion catalyst (TWC), preferably in the form of one or several washcoats, is present on the carrier at a total loading in the range of from 0.5 to 5 g/in³, more preferably in the range of from 1.5 to 4.5 g/in³, more preferably in the range of from 2.0 to 4.0 g/in³, and most preferably in the range of from 2.7 to 3.5 g/in³.

The three-way conversion catalyst of the present invention can have one single washcoat layer comprising at least one platinum group metal (PGM) on a support material. For instance, palladium can be impregnated on ceria-zirconia. In addition, rhodium can be further included in the single washcoat layer comprising palladium as the platinum group metal supported on ceria-zirconia, wherein rhodium can be additionally supported on high porosity alumina to form a preferred single washcoat layer comprising palladium supported on ceria-zirconia and rhodium supported on alumina. Promoter compounds like zirconia and/or baria can be optionally added to the single layer design of the preferred three-way conversion catalyst (TWC).

Alternatively, the three-way conversion catalyst (TWC) can comprise two or more washcoat layers, especially two washcoat layers comprising a bottom washcoat and a top washcoat. Each washcoat layer can have unique chemical catalytic functions depending on its exact composition. The bottom washcoat (or first coating) is applied on the substrate, and the top washcoat (or second coating) is applied on the bottom washcoat.

As far as the bottom washcoat or first washcoat (or first coating) is concerned, the combination of palladium and/or platinum is preferably added as platinum group metals (PGM), more preferably in the absence of rhodium. Other platinum group metals like ruthenium, osmium and/or iridium can be optionally present, together with palladium and/or platinum. In one preferred embodiment, the bottom washcoat can include palladium as the only platinum group metal (PGM), with platinum and rhodium being absent. Alternatively, platinum and palladium are combined in the bottom washcoat in the absence of any other platinum group metal (PGM).

Optionally, palladium, in the absence of platinum and rhodium, can be combined with other platinum group metals (PGM) like ruthenium, osmium and/or iridium in the bottom washcoat.

The platinum group metal (PGM) component of the bottom washcoat is supported on a refractory metal oxide support. Preferably, the refractory metal oxide support of the bottom washcoat is non-zeolithic. The refractory metal oxide support of the bottom washcoat preferably comprises a mixture of aluminum oxide and cerium oxide. Another preferred refractory metal support material of the bottom washcoat comprises aluminum oxide that is doped with lanthanum. The aluminum oxide as used in the refractory metal oxide support material can be preferably stabilized aluminum oxide. The aluminum oxide of the refractory metal oxide support of the bottom washcoat can also preferably be gamma aluminum oxide. The refractory metal oxide support of the bottom washcoat can optionally comprise additional metal oxides, like zirconia, ceria, baria and/or neodymia.

Another preferred refractory metal support material of the bottom washcoat comprises a mixture or mixed oxide of cerium oxide and aluminum oxide. Preferably, the mixture or the mixed oxide of ceria and alumina has a weight ratio of ceria to alumina from 10:90 to 90:10, 25:75 to 75:25, or 30:70 to 70:30, more preferably from 40:60 to 60:40, and even more preferably from 45:55 to 55:45.

Another preferred refractory metal support material of the bottom washcoat comprises aluminum oxide that is doped with lanthana (like La₂O₃). Alumina doped with lanthana refers to alumina containing a rather small amount of lanthana, preferably up to 10 wt %, more preferably up to 7 wt %, even more preferably up to 5 wt %, and most preferably up to 4 wt % lanthana, based on the total weight of the lanthana-doped alumina. The La-doped alumina (L-doped alumina) contains at least 0.5 wt %, more preferably at least 1 wt %, and most preferably at least 2 wt % lanthana, based on the total weight of the lanthana-doped alumina.

As far as the top washcoat or second washcoat (or second coating) is concerned, the combination of rhodium and palladium is preferably added as platinum group metals (PGM), preferably in the absence of platinum. Other platinum group metals like ruthenium, osmium and/or iridium can be optionally present, together with rhodium and palladium. In one preferred embodiment, the top washcoat can even include rhodium as the only platinum group metal (PGM), with platinum and palladium being absent. In another preferred embodiment, the top washcoat includes rhodium, palladium and platinum. Optionally, rhodium, in the absence of platinum and palladium, can be combined in the topcoat with other platinum group metals (PGM) like ruthenium, osmium and/or iridium.

The platinum group metal (PGM) component of the top washcoat is supported on a refractory metal oxide support. Preferably, the refractory metal oxide support of the top washcoat is non-zeolithic. The refractory metal oxide support of the top washcoat preferably comprises a mixture of aluminum oxide and cerium oxide. Another preferred refractory metal support material of the top washcoat comprises aluminum oxide that is doped with lanthanum. The aluminum oxide as used in the refractory metal oxide support material can be preferably stabilized aluminum oxide. The aluminum oxide of the refractory metal oxide support of the top washcoat can also preferably be gamma aluminum oxide. The refractory metal oxide support of the top washcoat of the present invention can optionally comprise additional metal oxides, like zirconia, ceria, baria and/or neodymia.

One preferred refractory metal support material of the top washcoat comprises a mixture or mixed oxide of cerium oxide and aluminum oxide. Preferably, the mixture or the mixed oxide of cerium oxide and aluminum oxide has a weight ratio of ceria to alumina from 10:90 to 90:10, 30:70 to 70:30, more preferably from 40:60 to 60:40, and even more preferably from 45:55 to 55:45.

Another preferred refractory metal support material of the top washcoat comprises aluminum oxide that is doped with lanthanum, like lanthana (like La₂O₃). Alumina doped with lanthana refers to alumina containing a rather small amount of lanthana, preferably up to 10 wt %, more preferably up to 7 wt %, even more preferably up to 5 wt %, and most preferably up to 4 wt % lanthana, based on the weight of the lanthana-doped alumina. The La-doped alumina contains at least 0.5 wt %, more preferably at least 1 wt %, and most preferably at least 2 wt % lanthana, based on the weight of the lanthana-doped alumina.

The generic exhaust gas treatment system according to the present invention comprises a three-way conversion catalyst (TWC) and a gasoline particulate filter function. In a preferred embodiment, the exhaust gas treatment system of the present invention comprises a first three-way conversion catalyst (TWC) followed by a gasoline particulate filter (GPF) coated with a second three-way conversion catalyst (TWC). For instance, the first three-way conversion catalyst (TWC) is in close-coupled position to the engine followed downstream by the gasoline particulate filter (GPF) coated with the second three-way conversion catalyst (TWC) which is preferably in close-coupled position to the first three-way conversion catalyst (TWC).

The gasoline particulate filter (GPF) of the exhaust gas treatment system of the present invention can be a coated filter or a bare (naked) filter. When the gasoline particulate filter (GPF) is not a coated filter, i.e. a bare or naked filter, there is no catalytically active coating on the filter medium. That is, particulates from the exhaust gas stream are retained and purged at the pores of the filter medium in a size-dependent manner, while no chemical catalytic transformation is carried out at the filter medium of the naked filter based on interaction with a catalytically active coating. The term “coated filter” (CF) generally refers to a device that is capable of removing particulate matter generated by a gasoline engine and carried over into the exhaust gas stream to be purged by the inventive exhaust gas treatment system of the present invention. The coated filter (CF) has a filter as an essential feature suitable for trapping particulates from the exhaust gas stream based on the presence of a porous medium through which the exhaust gas stream can flow while the particulate matter is retained at the pores. In order to limit the back-pressure to the exhaust gas stream, it is preferred to apply a coated filter. That is, the porous medium having the filter function can be coated with a catalytically active material optionally contributing to the conversion of pollutants from the exhaust gas stream flowing through the filter medium. The particulates captured at the filter pores are combusted to carbon dioxide at high temperature and/or by the additional aid of the catalytic coating. In this regard, it is preferred that the catalytically active coating on the coated filter (CF) contributes to preventing the clogging of the pores and build-up of back-pressure typically caused by the accumulation of particulates at the pores of the coated filter. A preferred catalytic coating on the coated filter of the gasoline particulate filter (GPF) is a three-way conversion catalyst (TWC), as it is herein described elsewhere. Accordingly, the coated filter (CF) preferably provides a second three-way conversion catalyst (TWC) functionality to the exhaust gas treatment system of the present invention. One possible coated filter (CF) is a four-way conversion catalyst (FWC), which more preferably is in close proximity to the three-way conversion catalyst (TWC), e.g. in close-coupled position to the first three-way conversion catalyst (TWC). As the skilled person will understand, the coated filter (CF) comprising a second three-way conversion catalyst (TWC), like a four-way conversion catalyst (FWC), integrates a typical three-way conversion catalyst (TWC) functionality with an additional particulate removal function. Accordingly, the exhaust gas treatment system of the present invention can preferably combine two three-way conversion catalyst (TWC) functions, wherein, more preferably, the second TWC positioned downstream further comprises a catalytic function for the removal of particulate matter, for instance due to the presence of a filter, preferably a gasoline particulate filter (GPF).

When the particulate filter is a coated particulate filter, the particulate filter is used as substrate on which the second three-way conversion catalyst (TWC) can be coated on the surface or the pores of the particulate filter. As already described in more detail above for the three-way conversion catalyst (TWC), the second three-way conversion catalyst (TWC) function of the coated filter (CF), preferably the four-way conversion catalyst (FWC), can be present in the form of one single washcoat, or several washcoats, like for instance two different washcoats or coatings.

The trapping of the particulate matter in the gasoline particulate filter (GPF) can occur, for example, by use of a particulate (or soot) filter, by use of a flow-through substrate having an internal tortuous path such that a change in direction of flow of the particulates causes them to drop out of the exhaust stream. A typical monolithic substrate has fine, parallel gas flow passages extending there through from an inlet or an outlet face of the substrate such that passages are open to fluid flow there through (“flow-through substrate”).

The flow-through substrate can be a monolithic substrate including a flow-through honeycomb monolithic substrate. The skilled person is familiar with flow-through substrates, which generally have fine, parallel gas flow passages extending from an inlet end to an outlet end of the substrate such that passages are open to fluid flow. The passages, which are essentially straight paths from their fluid inlet to their fluid outlet, are defined by walls on which a catalytic coating can be disposed so that gases flowing through the passages contact the catalytic material. The flow passages of the flow-through substrate are thin-walled channels, which can be of any suitable cross-sectional shape and size, such as trapezoidal, rectangular, square, sinusoidal, hexagonal, oval, circular or the like. The flow-through substrate can be ceramic or metallic as further described below. Flow-through substrates can, for example, have a volume of from about 50 in³ to about 1200 in³, a cell density (inlet openings) of from about 60 cells per square inch (cpsi) to about 1200 cpsi or about 200 to about 900 cpsi, or for example from about 300 to about 600 cpsi and a wall thickness of from about 50 to about 400 microns or about 100 to about 200 microns.

Suitable substrates are preferably ceramic substrates, which are made of any suitable refractory material, e.g. cordierite, cordierite-a-alumina, aluminum titanate, silicon titanate, silicon carbide, silicon nitride, zircon mullite, spodumene, alumina-silica-magnesia, zircon silicate, sillimanite, a magnesium silicate, zircon, petalite, a-alumina, an aluminosilicate and the like.

The most preferred substrates in the present invention are wall flow filter substrates. Wall flow filter substrates as understood by the skilled person have a plurality of fine, substantially parallel gas flow passages extending along the longitudinal axis of the substrate where, typically, each passage is blocked at one end of the substrate body, with alternate passages blocked at opposite end faces (“wall flow filter”). Suitable flow-through and wall-flow substrates are also taught, for example, in International Application Publication No. WO 2016/070090, which is incorporated herein by reference in its entirety.

Preferably, the wall-flow filter substrate comprises, more preferably consists of, a cordierite, a silicon carbide, an aluminum titanate, or a combination thereof.

Preferably, in the gasoline particulate filter (GPF) optionally comprising a second three-way conversion (TWC) functionality, more preferably a four-way conversion catalyst, a three-way conversion function is present on the particulate filter by permeating the walls of the particulate filter functionality. In this preferred embodiment, there is no layering of the three-way conversion catalytic material on the surface of the walls of the particulate filter function of the gasoline particulate filter (GPF). More preferably, in this preferred set-up, the resulting four-way conversion catalyst comprising a particulate filter function has a coated porosity that is less than that of the bare particulate filter. More preferably, the coated porosity may be between 75 and 98 % of the uncoated porosity, or the coated porosity may be between 80 and 95 % of the uncoated porosity, or the coated porosity may be between 80 and less than 93 % of the uncoated porosity.

The gasoline particulate filter (GPF) can preferably comprise a catalytically active coating comprising a three-way conversion catalyst (TWC) functionality. The three-way conversion catalyst (TWC) coating of the coated filter (CF), preferably the four-way conversion catalyst (FWC), can be preferably formed from a single washcoat composition that permeates the inlet side, the outlet side, or both, the inlet side and the outlet side of the particulate filter.

Alternatively, several three-way conversion catalyst (TWC) coatings, preferably two coatings, of the coated filter (CF), preferably the four-way conversion catalyst (FWC), can be formed from several, preferably two, washcoat compositions. Different washcoat compositions can be applied to permeate the inlet side and the outlet side. Alternatively, one single washcoat compositions or several washcoat compositions can be applied on the inlet side and the outlet side of the particulate filter.

The catalytically active coating of the three-way conversion catalyst (TWC) material on the coated filter (CF) may be present in an amount in the range of about 1 to about 5 g/in³ (about 60 to about 300 g/L). The uncoated porosity may be in the range of 55 to 70 %. More preferably, the coated filter (CF) comprises the three-way conversion catalyst (TWC) in an amount in the range of 120 to 244 g/L (about 1.0 to about 4.0 g/in³) and a porosity in the range of 55 to 70 %, wherein the particulate filter function comprises a wall thickness in the range of about 152 μm (6 mils) to about 356 μm (14 mils). In this embodiment, the three-way conversion catalyst (TWC) permeates the walls of the particulate filter, while there is no layering of the catalytic material on the surface of the walls of the particulate filter. There is preferably no three-way conversion catalytic material present outside the pores of the particulate filter walls.

Particular coated filters (CF), preferably four-way conversion catalysts, and their preparation are described in WO 2019/149929 A1 , WO 2019/149930 A1 and WO 2020/043885 A1 , which are all herein incorporated by reference in their entirety.

The coated filter (CF), preferably the four-way conversion catalyst (FWC), being a coated particulate filter can be prepared by applying the three-way conversion catalytic (TWC) coating on a particulate filter as follows:

Providing an appropriate particulate filter substrate, forming a slurry of a three-way conversion (TWC) catalytic material having a pH in the range of 2 to 7; and permeating the three-way conversion catalytic (TWC) material into the walls of the particulate filter to form the coated filter (CF), preferably four-way conversion catalyst (FWC), with a particulate filter function such that the coated filter (CF) has a coated porosity that is less than the uncoated porosity of the particulate filter. The slurry may have a dynamic viscosity in the range of about 5 to less than 40 mPas at 20° C. and solids content of 0-25 wt.-% solids. The pH may be in the range of 3 to 5. Preferably, there is no layering of the catalytic material on the surface of the walls of the particulate filter except optionally in areas of overlapped washcoat. In a preferred embodiment, there is no catalytic material outside the pores of the walls of the particulate filter. The coated porosity may be linearly proportional to a washcoat loading of the three-way conversion catalytic (TWC) material. The coated porosity may be between 75 and 98 % of the uncoated porosity, or even 80 and 95 % of the uncoated porosity, or even between 80 and less than 93 %. Preferably, the particulate filter may comprise 200-300 cells per square inch (OPSI) and a wall thickness in the range of 6-14 mil.

In order to address the objective of additionally reducing ammonia emission from a gasoline engine, the three-way conversion catalyst (TWC) and the coated filter (CF), preferably four-way conversion catalyst (FWC), of the exhaust gas treatment system of the present invention is combined with a suitable catalytic function for reducing tailpipe emission of ammonia. The present invention achieves such objective by including at least a combination of a selective catalytic reduction catalyst (SCR) and an ammonia oxidation catalyst (AMOx).

There are two basic options for including the selective catalytic reduction catalyst (SCR) and the ammonia oxidation catalyst (AMOx) into the exhaust gas treatment system of the present invention. In one first alternative, the selective catalytic reduction catalyst (SCR) and the ammonia oxidation catalyst (AMOx) are combined together on a substrate in one single layer. In a second alternative, the combination of the selective catalytic reduction catalyst (SCR) and the ammonia oxidation catalyst (AMOx) is a zoned catalytic function, in which the selective catalytic reduction catalyst (SCR) comprising the metal-promoted zeolite and the ammonia oxidation catalyst (AMOx), preferably comprising the additional three-way conversion (TWC) catalyst, are positioned on separate locations on a suitable carrier or support. Preferably, the selective catalytic reduction catalyst (SCR) comprising the metal-promoted zeolite is washcoated at the inlet zone of the catalytic function for reducing tailpipe emission of ammonia, and the ammonia oxidation catalyst (AMOx), preferably comprising the additional three-way conversion (TWC) catalyst, being washcoated at the outlet zone of the catalytic function for reducing tailpipe emission of ammonia.

The SCR catalyst as used in the present invention can comprise, for example, one or more metal oxide (e.g. a mixed oxide), a molecular sieve (preferably a metal-promoted molecular sieve) or combinations thereof.

The SCR catalyst preferably comprises one or more molecular sieve materials. More preferably, the SCR catalytic material comprises 8-member ring small pore molecular sieves containing a metal promoter. As used herein, “small pore” refers to pore openings which are smaller than about 5 Angstroms (e.g., about 2-5 Å, about 2-4 Å, about 3-5 Å, or about 3-4 Å, for example, at the order of ~3.8 Angstroms. One especially preferred 8-member ring small pore molecular sieve is an 8-member ring small pore zeolite.

The SCR catalytic material preferably comprises a zeolite, preferably a zeolite comprising a d6r unit. Thus, the SCR catalytic material can comprise a zeolite having a structure type selected from AEI, AFT, AFX, CHA, EAB, EMT, ERI, FAU, GME, JSR, KFI, LEV, LTL, LTN, MOZ, MSO, MWW, OFF, SAS, SAT, SAV, SBS, SBT, SFW, SSF, SZR, TSC, WEN, and combinations thereof. Preferred SCR catalytic materials comprise a zeolite with a structure type selected from the group consisting of CHA, AEI, AFX, ERI, KFL LEV, and combinations thereof. Especially preferred SCR catalytic materials comprises a zeolite with a structure type selected from CHA and AEI. Most preferred SCR catalytic materials comprise a zeolite with the CHA structure type. The SCR catalytic material comprising zeolitic chabazite preferably is a naturally occurring tec-tosilicate mineral of a zeolite group with an approximativ formula represented by (Ca, Na₂,K₂, Mg)Al₂Si₄O₁₂·6H₂O (e.g. hydrated calcium aluminum silicate). Three synthetic forms of zeolitic chabazite that can be favorably used in the SCR catalysts of the present invention are described in “Zeolite Molecular Sieves,”” by D. W. Breck, published in 1973 by John Wiley & Sons, which is hereby incorporated by reference. The three synthetic forms reported by Breck are Zeolite K-G, described in J. Chem. Soc., p. 2822 (1956), Barrer et al., Zeolite D, described in British Patent No. 868,846 (1961), and Zeolite R, described in U.S. Patent No. 3,030, to Milton, which are all herein incorporated by reference. Synthesis of another synthetic form of zeolitic chabazite, SSZ-13, is described in U.S. Pat. No. 4,544,538 to Zornes, which is herein incorporated by reference. A method of making yet another synthetic molecular sieve having chabazite structure, SAPO-44, is described in U.S. Pat. No. 6,162,415 to Liu et al., which is herein incorporated by reference.

The ratio of silica to alumina in molecular sieves useful as SCR catalytic materials in the present invention can vary over a wide range. Preferred molecular sieves useful as SCR catalytic materials have a silica to alumina molar ratio (SAR) in the range of 2 to 300, including 5 to 250, 5 to 200, 5 to 100, and 5 to 50. More preferably, the molecular sieve has a silica to alumina molar ratio (SAR) in the range of 10 to 200, 10 to 100, 10 to 75, 10 to 60, 10 to 50, 15 to 100, 15 to 75, 15 to 60, 15 to 50, 20 to 100, 20 to 75, 20 to 60, and 20 to 50. Even more preferably, with regard to the molecular sieve having any of the immediately preceding SAR ranges, the spherical particle of the molecular sieve has a particle size d₅₀ in the range of about 1.0 to about 5 microns, and more specifically, about 1.0 to about 3.5 microns, and the individual crystals of a molecular sieve component have a crystal size in the range of about 100 to about 250 nm.

Metal-promoted zeolite catalysts including, among others, iron-promoted and copper-promoted zeolite catalysts, for the selective catalytic reduction of nitrogen oxides with for instance ammonia are preferred. The promoter metal can be selected from Cu, Fe, Co, Ni, La, Ce, Mn, V, Ag, and combinations thereof. Preferred promoter metals are Cu, Fe, or combinations thereof. Accordingly, a preferred metal-promoted zeolite comprised in the selective catalytic reduction catalyst (SCR) of the present invention is either a copper-promoted zeolite or iron-promoted zeolite, especially a copper-promoted chabazite zeolite or iron-promoted chabazite zeolite, or both.

Preferred SCR catalysts do not contain any precious metal or platinum group metal, like for instance rhodium, palladium and/or platinum. Metal-promoted, particularly copper promoted aluminosilicate zeolites having the CHA structure type and a silica to alumina molar ratio greater than 1, have recently solicited a high degree of interest as catalysts for the selective catalytic reduction of nitrogen oxides in lean buming engines using nitrogenous reductants. The promoter metal content in such preferred catalysts, calculated as the oxide, is preferably at least about 0.1 wt. %, reported on a volatile-free basis. Preferably, the promoter metal comprises Cu, and the Cu content, calculated as CuO is in the range of up to about 10 wt. %, or more preferably 9, 8, 7, 6, 5, 4, 3, 2, 1, 0.5, and 0.1 wt. %, in each case based on the total weight of the calcined zeolite component reported on a volatile free basis. The Cu content, calculated as CuO, can be in the range of about 1 to about 4 wt. %.

One exemplary molecular sieve that can be useful as an SCR catalytic material is an aluminophosphate. Types of aluminophosphates include silicoaluminophosphate (SAPO), metallic aluminophosphate (MeAPO), and metallic silicoaluminophosphate (MeSAPO). The preparation of a synthetic form of an exemplary aluminophosphate molecular sieve, silicoaluminophosphate 34 (SAPO-34), is described in U.S. Pat. No. 4,440,871 to Lok et al. and U.S. Pat. No. 7,264,789 to Van Den et al., which are hereby incorporated by reference. A method of making yet another synthetic molecular sieve, SAPO-44, is described in U.S. Pat. No. 6,162,415 to Liu et al., which is hereby incorporated by reference.

The SCR catalyst of the present invention preferably comprises a metal oxide, e.g., a mixed oxide. As used herein, the term “mixed oxide” refers to an oxide that contains cations of more than one chemical element or cations of a single element in several states of oxidation. Mixed oxides that are suitable as SCR catalysts can include Fe/titania (e.g. FeTiO₃), Fe/alumina (e.g. FeAl₂O₃), Mg/titania (e.g. MgTiO₃), Mg/alumina (e.g. MgAl₂O₃), Mn/alumina, Mn/titania (e.g. MnOₓ/TiO₂) (e.g. MnOₓ/Al₂O₃), Cu/titania (e.g. CulTiO₃), Ce/Zr (e.g. CeZrO₂), Ti/Zr (e.g. TiZrO₂) and mixtures thereof. Additional examples of mixed oxides as SCR catalysts can be found in U.S. Patent Application Publiation No. 2001/0049339 to Schafer-Sindelindger et al. and U.S. Pat. No. 4,518,710 to Brennan et al., U.S. Pat. No. 5,137,855 to Hegedus et al., U.S. Pat. No. 5,476,828 to Kapteijn et al., U.S. Pat. No. 8,685,882 to Hong et al., and U.S. Pat. No. 9,101,908 to Jurng et al., which all incorporated by reference herein in their entireties.

The SCR catalyst can comprise one or more vanadium-containing components. Such compositions are generally referred to herein as “vanadia-based compositions”. In such embodiments, the vanadium can be in various forms, e.g., including but not limited to, free vanadium, vanadium ion, or vanadium oxides (vanadia), such as vanadium pentoxide (V₂O₅). As used herein, “vanadia” or “vanadium oxide” is intended to cover any oxide of vanadium, including vanadium pentoxide. A vanadia-based composition preferably comprises a mixed oxide comprising vanadia. The amount of vanadia in the mixed oxide can vary and, preferably, ranges from about 1 to about 10 percent by weight, based on the total weight of the mixed oxide. For example, the amount of vanadia can be at least 1 percent, at least 2 percent, at least 3 percent, at least 4 percent, at least 5 percent, or at least 6 percent, with an upper limit of about 10 percent by weight or no more than 10 percent, no more than 9 percent, no more than 8 percent, no more than 7 percent, no more than 6 percent, no more than 5 percent, or no more than 4 percent, with a lower limit of about 1 percent by weight.

Preferred SCR compositions comprise vanadium supported on a refractory real oxide such as alumina, silica, zirconia, titania, ceria, and combinations thereof are described in U.S. Pat. No. 4,010,238 to Shiraishi et al. and U.S. Pat. No. 4,085,193 to Nakajima et al., as well as in U.S. Patent Application Publication No. 2017/0341026 to Chen et al., which are incorporated by reference herein in their entireties. In other preferred embodiments, the SCR catalyst comprises a mixed oxide comprising vanadia/titania (V₂O₅/TiO₂), e.g., in the form of titania onto which vanadia has been dispersed. The vanadia/titania can optionally be activated or stabilized with tungsten (e.g. WO₃) to provide V₂O₅/TiO₂/WO₃, e.g., in the form of titania onto which V₂O₅ and WO₃ have been dispersed. The vanadia is not always truly in the form of a mixed metal oxide, rather, the metal oxide components (e.g., titania and vanadia) may be present as discrete particles. The amount of tungsten in such embodiments can vary and can range, e.g., from about 0.5 to about 10 percent by weight based on the total weight of the mixed oxide. For example, the amount of tungsten can be at least 0.5 percent, at least 1 percent, at least 2 percent, at least 3 percent, at least 4 percent, at least 5 percent, er at least 6 percent, with an upper limit of about 10 percent by weight or no more than 10 percent, no more than 9 percent, no more than 8 percent, no more than 7 percent, no more than 6 percent, no more than 5 percent, or no more than 4 percent, with a lower limit of about 0.5 percent by weight.

Exemplary vanadia-based SCR compositions can comprise components including, but not limited to, V₂O₅/TiO₂, V₂O₅/WO₃/TiO₂/SiO₂, or combinations thereof. Additional vanadium-containing SCR catalyst compositions are described, for example, in U.S. Pat. No. 4,782,039 to Lindsey and U.S. Pat. No. 8,975,206 to Schermanz et al., as well as International Application Publication No. WO 2010/121280 to Schermanz et al., which are incorporated herein by reference in their entireties.

Certain vanadia-based SCR compositions can comprise other active components (e.g., other metal oxides). For example, in some embodiments, vanadia-based SCR compositions suitable for use in the disclosed systems comprise vanadia and antimony. Such a vanadia-based SCR composition, in certain embodiments, comprises a composite oxide comprising vanadium and antimony, which can be supported on a refractory metal oxide (e.g., TiO₂, SiO₂, WO₃, Al₂O₃, ZrO₂, or a combination thereof). Exemplary vanadia-based SCR compositions comprising vanadia and antimony are disclosed in U.S. Pat. No. 4,221,768 to Inoue et al., International Application Publication No. WO 2017/101449 to Zhao et al., and International Application Nos. PCT/CN2016/113637, filed Dec. 30, 2016; PCT/CN2015/076895, filed Apr. 17, 2015, and PCT/CN2015/097704, filed Dec. 17, 2015, all of which are incorporated herein by reference in their entireties. In certain embodiments, the SCR catalyst can comprise a mixture of a vanadium-based SCR composition and a molecular sieve.

The term “ammonia oxidation catalyst” (AMOx) as used herein refers to a catalyst containing one or more catalytic metals on a substrate or support, preferably alumina support, suitable to convert excess ammonia in the exhaust system into nitrogen.

Ammonia oxidation (AMOx) generally refers to a process in which ammonia is preferably re-acted with oxygen to produce N₂. The ammonia oxidation catalyst AMOx is capable of predominantly converting the excess ammonia to N₂, with only minimal nitrogen oxide by-products, like nitrogen oxides NOx, preferably at a wide range of temperatures, where ammonia slip could otherwise escape in the vehicles driving cycle. Accordingly, the AMOx catalyst also produces minimal N₂O, which is an undesired potent greenhouse gas.

The composition of the AMOx catalyst is not particularly limited, and various compositions known to be suitable for this purpose can be employed in the context of the disclosed exhaust gas treatment systems. It is preferred that the ammonia oxidation catalytic component generally is a composition, preferably a physical mixture, comprising one or more platinum group metals supported on a refractory metal oxide.

The AMOx catalyst can preferably include at least one supported platinum group metal, which is effective to remove ammonia from the exhaust gas stream. Preferred platinum group metals include ruthenium, rhodium, iridium, palladium, platinum, silver or gold. The platinum group metal component can include physical mixtures and/or chemical and/or atomically doped combinations of ruthenium, rhodium, iridium, palladium, platinum, silver and gold. In very preferred embodiments, the AMOx catalyst comprises a precious metal or platinum group metal (PGM) such as platinum, palladium, rhodium, or combinations thereof. It is especially preferred that the AMOx catalyst comprises platinum. It is very preferred that the at least one platinum group metal, most preferably platinum, optionally platinum and rhodium, is present in an amount in the range of about 0.008% to about 2% by wt (metal), based on Pt group metal support loading.

The AMOx catalytic function according to the present invention comprises a total loading of precious metal or platinum group metal from about 0.1 g/ft³ to about 10 g/ft³, preferably about 0.3 g/ft³ to about 5 g/ft³, more preferably about 0.5 g/ft³ to about 3 g/ft³, even more preferably about 0.8 g/ft³ to about 2 g/ft³, calculated as the total weight of precious metal or platinum group metal over the volume of the AMOx catalyst. Alternatively or additionally, the AMOx composition disclosed herein comprises total precious metal or platinum group metal loading from about 0.01 wt. % to about 2 wt. %, preferably from about 0.05 wt. % to about 1 wt. %, more preferably from about 0.08 to about 0.5 wt. %, based on the weight of the dry AMOx catalyst component.

Preferably, the precious metal component or platinum group metal of the ammonia oxidation catalytic component comprises, preferably consists of, platinum (Pt). The ammonia oxidation catalyst comprises or consists of the platinum (Pt) component in an amount in the range of about 0.5 g/ft³ to about 10 g/ft³, more preferably in the range of about 0.01 wt. % to about 2 wt. %, or alternatively, at total loadings of platinum and/or amounts of platinum as defined above for the generic precious metal or platinum group metal.

Alternatively, the precious metal component or platinum group metal of the ammonia oxidation catalytic component comprises, preferably consists, of palladium (Pd). The ammonia oxidation catalyst comprises or consists of the palladium (Pd) component in an amount in the range of about 0.5 g/ft³ to about 10 g/ft³, more preferably in the range of about 0.01 wt. % to about 2 wt. %, or alternatively, at total loadings of palladium and/or amounts of palladium as defined above for the generic precious metal or platinum group metal.

Alternatively, the precious metal component or platinum group metal of the ammonia oxidation catalytic component comprises, preferably consists of, rhodium (Rh). The ammonia oxidation catalyst comprises or consists of the rhodium (Rh) component in an amount in the range of about 0.5 g/ft³ to about 10 g/ft³, more preferably in the range of about 0.01 wt. % to about 2 wt. %, or alternatively, at total loadings of rhodium and/or amounts of rhodium as defined above for the generic precious metal or platinum group metal.

The skilled person will be familiar with determining the loadings of precious metals or platinum group metals on catalytic coatings. For instance, XRF (X-ray fluorescence) and inductively coupled plasma atomic emission spectroscopy (ICP-AES) can be used for measuring the catalytic loading.

The precious metal or platinum group metal of the AMOx catalyst of the present invention is preferably supported, for instance on a high surface area refractory metal oxide support. Examples of suitable high surface area refractory metal oxides include, but are not limited to, alumina, silica, titania, ceria, and zirconia, as well as physical mixtures, chemical combinations and/or atomically doped combinations thereof. The refractory metal oxide may contain a mixed oxide such as silica-alumina, amorphous or crystalline aluminosilicates, alumina-zirconia, alumina-lan-thana, alumina-chromia, alumina-baria, alumina-ceria, and the like. An exemplary refractory metal oxide comprises high surface area y-alumina, preferably having a specific surface area of about 50 to about 300 m²/g.

Preferred refractory metal oxide supports useful in the AMOx compositions of the present invention are alumina or doped alumina materials, such as Si-doped alumina materials (including, but not limited to 1-10% SiO₂—Al₂O₃), titania or doped titania materials, such as Si-doped titania materials (including, but not limited to 1-15% SiO₂—TiO₂) or zirconia or doped zirconia materials, such as Si-doped ZrO₂ (including, but not limited to 5-30% SiO₂—ZrO₂).

High surface area metal oxide supports, such as alumina or titania support materials, typically exhibit a total surface area (BET) of about 50 m²/g to about 400 m²/g, and preferably from about 60 m²/g to about 350 m²/g, for example from about 90 m²/g to about 250 m²/g.

The refractory metal oxide support material preferably has total pore volume (BET) in the range of about 0.3 to about 1.5 cm³/g. The active alumina has mean pore diameter (BET) in the range of about 2 to about 50 nm.

In one or more embodiments, the ammonia oxidation catalyst (AMOx) has particle size distribution D₅₀ from about 1 micron to about 10 microns, and/or the ammonia oxidation catalyst has particle size distribution d₉₀ from about 2 microns to about 30 microns.

In one or more embodiments, the ammonia oxidation catalyst (AMOx) has a surface area (BET) in the range of about 50 to about 700 m²/g. In one or more embodiments, the ammonia oxidation catalyst has mean pore volume (BET) in the range of about 0.3 to about 1.5 cm³/g. In one or more embodiments, the ammonia oxidation catalyst has mean pore diameter (BET) in the range of about 2 to about 50 nm. In one or more embodiments, the ammonia oxidation catalyst is coated on a substrate with a dry gain from about 0.3 to about 3.0 g/in³.

In a preferred embodiment, the ammonia oxidation catalyst (AMOx) of the exhaust gas treatment system of the present invention comprises an additional three-way conversion catalyst (TWC). The skilled person will be familiar with the common features of the three-way conversion catalyst (TWC) as it is described in the art. In addition, the three-way conversion catalyst (TWC) has already described above with respect to TWC to be provided in close-coupled position of the outlet of the gasoline engine. Accordingly, these descriptions also apply again to the three-way conversion catalyst (TWC) as it is added to the ammonia oxidation catalyst (AMOx) of the exhaust gas treatment system of the present invention.

The most important difference between the three-way conversion catalyst (TWC) preferably included into the ammonia oxidation catalyst (AMOx) and an ammonia oxidation catalyst (AMOx) as such is that the three-way conversion catalyst (TWC) includes an oxygen storage component (OSC). It is common general knowledge that the presence of an oxygen storage component (OSC) in a three way conversion catalyst (TWC) is critical for concerted removal of the nitrogen oxides (NOx), carbon monoxide (CO) and hydrocarbons (HC) from an exhaust gas stream of a gasoline engine. Accordingly, the preferred three-way conversion catalyst (TWC) to be included into the ammonia oxidation catalyst (AMOx) of the exhaust gas treatment system of the present invention includes an additional oxygen storage component (OSC). As already described herein elsewhere, a preferred oxygen storage component (OSC) is a ceria-based material, i.e. a cerium oxide-based material that can be preferably applied as a support material for the at least one platinum group metal of the three-way conversion catalyst (TWC) of the ammonia oxidation catalyst (AMOx) of the inventive exhaust gas treatment system of the present invention. Especially preferred, as already described in greater detail herein, is a material comprising one or more oxide of cerium, or ceria with other oxides. Very preferred are mixed oxides (or even mixtures) of ceria with zirconia.

The ammonia oxidation catalyst (AMOx) of the inventive exhaust gas treatment system of the present invention, in some embodiments, can lack an additional oxygen storage component (OSC) thereby effectively also lacking a three-way conversion catalyst (TWC), especially in situations when an ammonia oxidation catalyst (AMOx) as herein defined is combined in one single catalytic layer with an additional selective catalytic reduction catalyst (SCR). Alternatively, the ammonia oxidation catalyst (AMOx) of the exhaust gas treatment system of the present invention can preferably comprise a catalytic function that constitutes a three-way conversion catalyst (TWC) due to the presence of inter alia an oxygen storage component (OSC). The latter configuration is especially preferred when the catalytic function for reducing the tailpipe emission of ammonia includes at least a combination of a selective catalytic reduction catalyst (SCR) and an ammonia oxidation catalyst (AMOx), wherein a zoned presentation of the latter two catalytic functions, is chosen. In this preferred configuration, the selective catalytic reduction catalyst (SCR) and the ammonia oxidation catalyst (AMOx) with the optional three-way conversion catalyst (TWC) are positioned separately, preferably on the inlet and the outlet of the flowthrough support material, respectively.

One advantage of the zoned configuration of the selective catalytic reduction catalyst (SCR) and the ammonia oxidation catalyst (AMOx), preferably comprising an additional three-way conversion catalyst (TWC), is that it is possible to use a significantly reduced amount of the selective catalytic reduction catalyst (SCR) and/or the ammonia oxidation catalyst (AMOx) preferably comprising the three-way conversion catalyst (TWC) when compared with the configurations, in which the selective catalytic reduction catalyst (SCR) and the ammonia oxidation catalyst (AMOx) are combined in one single catalytic washcoat layer. Without being bound to a particular theory, the inventors believe that the zoned presentation of the the selective catalytic reduction catalyst (SCR) and the ammonia oxidation catalyst (AMOx) has the technical advantage that the latter two catalytic functions are not in direct contact to each other, even over extended operation of the corresponding exhaust gas treatment system during challenging real-life conditions including long ageing of the whole system under high temperature and rough environmental conditions. Accordingly, due to the permanent separation of the catalyst functions on different locations, the inventors believe that the selective catalytic reduction catalyst (SCR) and the ammonia oxidation catalyst (AMOx) with the preferred three-way conversion catalyst (TWC) cannot directly interact with each other and/or negatively affect the mutual stability of the respective catalytic functions thereby allowing for better long-term stability and effectiveness of the whole catalytic function for reducing emission of ammonia at the tailpipe. Clearly, the additional option of limiting or even substantially reducing catalytic amounts in a more efficient or at least comparably efficient exhaust gas treatment system capable of satisfying future emission regulations provides high technical benefit.

When the selective catalytic reduction catalyst (SCR) and the ammonia oxidation catalyst (AMOx) are combined on a substrate in one single layer, it is preferred to prepare the single layer from one combined slurry comprising the selective catalytic reduction catalyst (SCR) comprising the metal-promoted zeolite and the ammonia oxidation catalyst (AMOx). However, the single, combined slurry used for the preparation of the single layer comprising the catalytic function for reducing the tailpipe emission of ammonia is preferably obtained from blending a first and second slurry that are separately prepared. The first slurry is used for the preparation of an ammonia oxidation catalyst (AMOx) comprising at least one catalytically active metal on an alumina support. The second slurry is used for the preparation of the selective catalytic reduction catalyst (SCR) comprising a metal-promoted zeolite. The first and the second slurry are blended to the single, combined slurry comprising at least the combination of the selective catalytic reduction catalyst (SCR) and the ammonia oxidation catalyst (AMOx) to obtain the inventive single slurry, single layer design according to this first alternative of the catalytic function for reducing tailpipe emission of ammonia of the exhaust gas treatment system of the present invention.

Accordingly, in one preferred alternative, the method for preparing the exhaust gas treatment system of the present invention comprises the steps of providing a three-way conversion catalyst (TWC) and a gasoline particulate filter (GPF), preferably a four-way conversion catalyst (FWC), preparing a first slurry comprising the ammonia oxidation catalyst (AMOx) by impregnating at least one catalytically active metal on an alumina support, preparing a second slurry comprising the selective catalytic reduction catalyst (SCR) comprising a metal-promoted zeolite, blending the first slurry and the second slurry to obtain a single, combined slurry comprising the ammonia oxidation catalyst (AMOx) from the first slurry and the selective catalytic reduction catalyst (SCR) from the second slurry, impregnating a support with the single, combined slurry to obtain the catalytic function for reducing the tailpipe emission of ammonia comprising the ammonia oxidation catalyst (AMOx) and the selective catalytic reduction catalyst (SCR) combined in a single layer on the support, and positioning the catalytic function for reducing the tailpipe emission of ammonia comprising the ammonia oxidation catalyst (AMOx) and the selective catalytic reduction catalyst (SCR) downstream to the three-way conversion catalyst (TWC) and the gasoline particulate filter (GPF), preferably the four-way conversion catalyst (FWC).

The at least one catalytically active metal on an alumina support, preferably platinum and/or rhodium, or alternatively, palladium and/or rhodium, or even the combination of platinum and palladium with rhodium, impregnated on alumina, preferably zirconia-doped alumina, is preferably thermally fixed to obtain the first slurry. The solid content of the first slurry preferably is in the range of 50 to 85 wt %, more preferably 60 to 80 wt %, or even more preferably 70 to 75 wt %. Alternatively, the at least one catalytically active metal on an alumina support can lack any rhodium and include platinum and/or palladium in combination with at least one non-platinum group metal, like titanium and/or manganese replacing rhodium, typically impregnated on alumina support, especially by thermal fixation. The solid content of the first slurry preferably is in the range of 50 to 85 wt %, more preferably 55 to 75 wt %, or even more preferably 60 to 70 wt %.

It is preferred that the particle size distribution D₉₀ of the first slurry comprising the ammonia oxidation catalyst (AMOx) comprising at least one catalytically active metal on an alumina support is in the range of 1 to 38 microns, preferably 5 to 30 microns, more preferably 8 to 27 microns, and most preferably 12 to 22 microns.

It is further preferred in this method that the particle size distribution D₉₀ of the single, combined slurry used for obtaining the catalytic function for reducing the tailpipe emission of ammonia comprising the ammonia oxidation catalyst (AMOx) and the selective catalytic reduction catalyst (SCR) combined in a single layer on the support is in the range of 2 to 50 microns, preferably 5 to 30 microns, more preferably 8 to 25 microns, and most preferably 10 to 17 microns.

In a preferred embodiment, the second slurry comprising the selective catalytic reduction catalyst (SCR) can already comprise the metal-promoted zeolite comprising the catalytic function. That is, the metal-promoted zeolite is formed separately, e.g. by metal-exchange or metal pro-motion of a zeolite lacking the metal, before the second slurry is formed by providing the metal-promoted zeolite into the second slurry. In this preferred embodiment, the metal-promoted zeolite, like for instance a copper-or iron-promoted zeolite, more preferably a copper-or iron-promoted chabazite zeolite, is added to the second slurry before the second slurry is blended with the first slurry comprising the ammonia oxidation catalyst (AMOx) comprising at least one catalytically active metal on an alumina support. It is preferred that the particle size distribution D₉₀ of the second slurry comprising the selective catalytic reduction catalyst (SCR) is in the range of 0.5 to 25 microns, preferably 1 to 20 microns, more preferably 2 to 15 microns, and most preferably 3 to 8 microns. Optionally, zirconia can be added to the second slurry, preferably at a solid content of 25 to 60 wt %, more preferably 30 to 50 wt %, or most preferably 35 to 45 wt %. Subsequently, the combined slurry used for preparing the catalytic function for reducing the tailpipe emission of ammonia comprising the ammonia oxidation catalyst (AMOx) and the selective catalytic reduction catalyst (SCR) combined in one single layer is formed by impregnating a support with the combined slurry.

In another preferred alternative of the method for the preparation of the exhaust gas treatment system of the present invention, the combined slurry comprising the ammonia oxidation catalyst (AMOx) from the first slurry and the selective catalytic reduction catalyst (SCR) from the second slurry is obtained by using a second slurry, in which the metal-promoted zeolite of the selective catalytic reduction catalyst (SCR) is prepared by an in slurry ion metal ion exchange process in the second slurry comprising the steps of providing a slurry comprising a zeolite, which is not metal-promoted or metal-promoted, and carrying out metal exchange of the zeolite by ion exchange in the slurry to obtain the second slurry comprising the selective catalytic reduction catalyst (SCR) comprising the metal-promoted zeolite. It is preferred that the particle size distribution D₉₀ in the second slurry comprising the selective catalytic reduction catalyst (SCR) comprising the metal-promoted zeolite is in the range of 0.5 to 25 microns, preferably 1 to 20 microns, more preferably 2 to 15 microns, and most preferably 3 to 8 microns. Optionally, zirconia can be added to the second slurry, preferably at a solid content of 25 to 60 wt %, more preferably 30 to 50 wt %, or most preferably 35 to 45 wt %. It is further preferred in this preferred alternative method that the particle size distribution D₉₀ of the single, combined slurry used for obtaining the catalytic function for reducing the tailpipe emission of ammonia comprising the ammonia oxidation catalyst (AMOx) and the selective catalytic reduction catalyst (SCR) combined in a single layer on the support is in the range of 2 to 50 microns, preferably 5 to 30 microns, more preferably 8 to 25 microns, and most preferably 10 to 17 microns.

The final single layer washcoat obtained from impregnating the combined slurry, optionally after coating, drying (e.g. at 120 to 180° C.) and calcining (e.g. 400 to 600° C.) to obtain the catalytic function for reducing the tailpipe emission of ammonia, preferably has a total amount of 0.2 to 35 g/in³, more preferably 0.5 to 15 g/in³, even more preferably 0.8 to 5 g/in³, like 1.0 to 3.5 g/in³, or most preferably 1.5 to 2.5 g/in³.

The loading of the platinum group metal on the support in the single layer approach is generally from 0.2 to 28 g/ft³, more preferably from 0.5 to 17 to g/ft³, even more preferably 1 to 8 g/ft³, most preferably from 2 to 5 g/ft³ over the volume of the AMOx catalyst.

The catalytic function for reducing the tailpipe emission of ammonia comprising the ammonia oxidation catalyst (AMOx) and the selective catalytic reduction catalyst (SCR) combined in a single layer on the support is coated on a suitable substrate, preferably a typical flowthrough substrate. The substrate can be typically a monolith. It is preferred that the substrate has a honeycomb structure. Especially preferred is a ceramic honeycomb substrate.

According to the second alternative, the combination of the selective catalytic reduction catalyst (SCR) and the ammonia oxidation catalyst (AMOx) can be presented as a zoned catalytic function, in which the selective catalytic reduction catalyst (SCR) comprising the metal-promoted zeolite and the ammonia oxidation catalyst (AMOx) preferably comprising the additional three-way conversion (TWC) catalyst are positioned on separate locations on a suitable carrier or support. The different zones for the various catalytic functions are positioned along the axial direction of the catalyst and the substrate and/or the exhaust gas stream from the gasoline engine.

Preferably, the selective catalytic reduction catalyst (SCR) comprising the metal-promoted zeolite is washcoated at the inlet zone of the catalytic function for reducing tailpipe emission of ammonia, and the ammonia oxidation catalyst (AMOx) preferably comprising the additional three-way conversion (TWC) catalyst being washcoated at the outlet zone of the catalytic function for reducing tailpipe emission of ammonia.

With respect to the inlet zone, i.e. the first zone, the selective catalytic reduction catalyst (SCR) comprising the metal-supported zeolite can be selected and prepared like the SCR catalyst to be used in the first alternative being based on a single layer comprising the combination of the selective catalytic reduction catalyst (SCR) and the ammonia oxidation catalyst (AMOx).

However, it is preferred to use a lower amount of the selective catalytic reduction catalyst (SCR) comprising the metal-supported zeolite in the zoned approach when compared with the alternative single layer approach.

The inlet zone of the substrate in the zoned approach can be coated with the SCR catalyst comprising the metal-supported zeolite according to established washcoating procedures, with which the skilled person will be familiar with. One preferred option is to prepare the catalytic washcoat comprising the SCR catalyst comprising the metal-supported zeolite according to the description given elsewhere herein for the composition and preparation of the SCR catalyst comprising the metal-supported zeolite present in the single layer approach.

With respect to the outlet zone, i.e. the second zone, an ammonia oxidation catalyst (AMOx) preferably comprising the three-way conversion catalyst (TWC) including at least one platinum group metal, an oxygen storage component (OSC), preferably comprising ceria-zirconia, and optionally a promoter, preferably comprising baria, is coated to form the catalytic function for reducing tailpipe emission of ammonia.

The outlet zone of the substrate in the zoned approach can be coated with the ammonia oxidation catalyst (AMOx) preferably comprising the additional three-way conversion catalyst (TWC) according to established washcoating procedures, with which the skilled person will be familiar with.

One preferred option is to prepare the catalytic washcoat comprising the ammonia oxidation catalyst (AMOx) comprising the additional three-way conversion catalyst (TWC) according to the description given elsewhere herein for the composition and preparation of the ammonia oxidation catalyst (AMOx) preferably comprising the additional three-way conversion catalyst (TWC) in the single layer approach.

For instance, the ammonia oxidation catalyst (AMOx) preferably comprising the additional three-way conversion catalyst (TWC) can comprise at least one catalytically active metal on an alumina and/or ceria/zirconia support, preferably platinum and/or rhodium, or alternatively, palladium and/or rhodium, or even the combination of platinum and palladium with rhodium. In a preferred embodiment, platinum is supported on ceria-zirconia and rhodium, or rhodium and platinum, is supported on alumina, preferably lanthanum-doped alumina or ceria-alumina. The slurry used for preparation of the AMOx comprising the at least one catalytically active metal and the support material may not be thermally fixed of the at least one platinum group metal on the support. It is preferred that the slurry and the resulting washcoat with the AMOx also comprises a typical promoter for better stability, preferably baria. It is preferred that the particle size distribution D₉₀ in the slurry comprising the ammonia oxidation catalyst (AMOx) comprising the additional three-way conversion catalyst (TWC) is in the range of 1 to 45 microns, preferably 4 to 35 microns, more preferably 8 to 35 microns, and most preferably 15 to 25 microns.

It is further preferred in this invention that the particle size distribution D₉₀ of the single, combined slurry used for obtaining the catalytic function for reducing the tailpipe emission of ammonia comprising the ammonia oxidation catalyst (AMOx) and the selective catalytic reduction catalyst (SCR) combined in a single layer on the support is in the range of 2 to 50 microns, preferably 5 to 30 microns, more preferably 8 to 25 microns, and most preferably 10 to 17 microns.

The loading of the platinum group metal on the support in the zoned approach is generally from 0.2 to 28 g/ft³, more preferably from 0.5 to 17 to g/ft³, even more preferably 1 to 8 g/ft³, most preferably from 2 to 5 g/ft³ over the volume of the AMOx catalyst.

In the zoned configuration, the amount of total washcoat preferably is in an amount of 0.2 to 35 g/in³, more preferably 0.5 to 15 g/in³, even more preferably 0.8 to 5 g/in³, like 1.0 to 3.5 g/in³, or most preferably 1.5 to 2.5 g/in³.

The present invention is also directed to a method treating an exhaust gas stream from a gasoline engine comprising the steps of providing an exhaust gas stream from a gasoline engine comprising ammonia, and contacting the exhaust gas stream comprising ammonia with the exhaust gas treatment system according to the present invention to reduce the ammonia emission in the exhaust gas stream at the tailpipe.

### EXAMPLES

### Catalyst Preparation Test Description

### Three-Way Conversion Catalyst (TWC): 80 g/ft³ PtPdRh 0/72/8

This technology contains Pd impregnated on high porosity alumina in a single layered design. The main components of the slurry are high porosity alumina and ceria-zirconia, with Pd impregnation on the latter while Rh is supported on the former using aqueous solutions of Palladium and Rhodium nitrates, respectively. The final dry Pd content is 72 g/ft³, while the Rh content after drying is 8 g/ft³. In both cases (Pd or Rh), the process entails Pd or Rh-impregnation on the selected support, followed by thermal fixation of the PGM-containing frit (60-75% solids) at 400-600° C. for 2-4 hrs.

Slurries were prepared from the calcined PGM-containing frits under constant stirring using distilled water and a surfactant such as n-octanol. Zirconia and/or baria are added during slurry preparation using appropriate precursors in the range of 1 to 4 wt. % for zirconia and 1 to 10 wt. % of total solids for baria, respectively. Slurry solid content was adjusted (35-45%) to enhance pH and viscosity measurements and wet milling. After milling, the pH was adjusted by nitric acid (3.5-4.5). Slurry particle size distribution (Deo) was also measured after milling and falls in the range 13-19 μm.

Ceramic honeycomb flowthrough substrates (4.66×4.5″, 600/4) were coated, dried (120-180° C.) and calcined (400-600° C.) in air. Total wash coat loading is 2.8-3.5 g/in³.

### Four-Way Conversion Catalyst (FWC): 10 G/ft³ PtPdRh 0/8/2

This formulation contains Pd impregnated on high porosity alumina using a single slurry with a wash coat load of 1.5 g/in³. The main components of the slurry are high porosity alumina and ceria-zirconia, with Pd impregnation on the latter while Rh is supported on the former using aqueous solutions of Palladium and Rhodium nitrates, respectively. The final dry Pd content of is 8 g/ft®, while the Rh content after drying is 2 g/ft³. In both cases (Pd or Rh), the process entails Pd or Rh-impregnation on the selected support, followed by thermal fixation of the PGM-containing frit (60-75% solids) at 400-600° C. for 2-4 hrs.

The calcined PGM-containing frits were made into slurry under constant stirring using distilled water and a surfactant such as n-octanol. Zirconia and/or baria are added during slurry preparation using appropriate precursors in the ranges of 1 to 4 wt. % for zirconia and 1 to 5 wt. % of total solids for baria, respectively. The slurry solid content was adjusted (35-42%) to enhance pH and viscosity measurements and wet milling. After milling, the pH was adjusted by nitric acid (3.2-4.0). Slurry particle size distribution (D90) was also measured before and after slurry milling (10-15 μm) at the requisite solid content.

Ceramic honeycomb wall flow substrates (4.66×4″, 300/8) were coated, dried (120-180° C.) and calcined (400-600° C.) in air.

### Reference System (TWC UF): 4 G/ft³ 0/3/1 Pt/Pd/Rh

The technology contains Pd and Rh on high porosity alumina and ceria-zirconia supports and baria. The technology is a low wash coat three-way catalyst for underfloor applications for HC, CO and NOx clean-up. The main components of the slurry are high porosity alumina and ceria-zirconia, with Pd impregnation on the latter while Rh is supported on the former using aqueous solutions of Palladium and Rhodium nitrates, respectively. The final dry Pd content is 3 g/ft³, while the Rh content after drying is 1 g/ft³. This slurry preparation involves wet impregnation of precious metals on the selected supports followed by wet milling after appropriate pH adjustments. Slurry solid content was also adjusted (35-45%) to enhance pH and viscosity measurements and wet milling. After milling, the pH was adjusted by nitric acid (3.5-5.0). Slurry particle size distribution (D90) was also measured after milling and falls in the range 12-22 μm.

Ceramic honeycomb flowthrough substrates (5.66×3″, 400/3) were coated, dried (120-180° C.) and calcined (400-600° C.) in air. The total wash coat amount is in the range 1.5-2.5 g/in³.

### Inventive Example 1 (SCR/AMOx): 4 G/ft³ 3/0/2 Pt/Pd/Rh

This catalyst is a single slurry single layer design that combines PGM and zeolite in one slurry. Pt and Rh are sequentially impregnated on zirconia-doped high porosity alumina at high solid content followed by thermal fixation. The slurry solids are in the range 70-75%. Wet milling to D90 in the range 12-22 microns completes the first slurry preparation step. The next step involves a separate slurry preparation with Cu-chabazite zeolite by stirring the zeolite in distilled water and addition of zirconia at solid contents in the range 35-45%. The zeolite slurry is dispersed by low energy mixing to a D90 in the range 3-8 microns. The final slurry process entails blending the PGM-containing slurry and the zeolite slurry followed by thorough mixing. Particle size distribution of final slurry (D90) is in the 10-17 microns range.

Ceramic honeycomb flowthrough substrates (5.66×3″, 400/3) were coated, dried (120-180° C.) and calcined (400-600° C.) in air. The total wash coat amount is in the range 2.5-3.5 g/in³.

### Inventive Example 2 (SCR/AMOx): 4 G/ft³ 4/0/0 Pt/Pd/Rh

This catalyst is also a single slurry single layer design that combines PGM and zeolite in one slurry. The difference in view of inventive example 1 is that Rh is now replaced with Ti and Mn, which are sequentially impregnated after Pt on high porosity alumina from their respective precursors at high solid content 60-70% followed by thermal fixation. The calcined powder is made into slurry by stirring in distilled water at appropriate pH and wet milling to PSD in the D₉₀ range 12-22 microns to complete the first slurry preparation step. The next step involves a separate slurry preparation with Cu-chabazite zeolite by stirring of the zeolite in distilled water and addition of zirconia at solid contents in the range 35-45%. The zeolite slurry process is different from that in example 1 in that the Cu-exchange is done during the slurry process called ISIE (In slurry ion exchange). The zeolite slurry is dispersed by low energy mixing to a D₉₀ in the 3-8 microns range. The final slurry process entails blending the PGM-containing slurry and the zeolite slurry followed by thorough mixing. Particle size distribution of final slurry (D₉₀) is in the 10-17 microns range.

Ceramic honeycomb flowthrough substrates (5.66×3″400/3) were coated, dried (120-180° C.) and calcined (400-600° C.) in air. The total wash coat amount is 1.0-1.5 g/in³.

### Inventive Example 3 (SCR/TWC-AMOx): 3 G/ft³ 2/0/1 Pt/Pd/Rh

This formulation is designed using a wash coat zoning concept, wherein the axial length is di-vided into two zones (inlet/outlet) to accommodate wash coats with different compositions and functions in a specific zone along the axial length of the catalysts. The inlet zone contains Cu-chabazite zeolite prepared like the zeolite slurry of inventive example 1. However, the zeolite amount used is less than in inventive example 1 (half of total zeolite in inventive example 1).

The Cu-chabazite slurry preparation (inlet SCR zone) is done by stirring Cu-chabazite in distilled water with zirconia addition at solid contents in the range 35-45% followed by dispersion mixing.

The outlet zone contains Pt and Rh on high porosity alumina and ceria-zirconia supports. The latter component confers oxygen storage capacity and enhances three-way catalyst functionality. The slurry also contains barium oxide from preferred precursors. Pt (50%) is impregnated on ceria-zirconia and PtRh on lanthanum-doped high porosity alumina. This slurry does not involve thermal fixation of PGM, enhanced mainly by the zoned wash coat concept, which mitigates negative zeolite/PGM interaction. The separate PGM frits are blended and diluted in distilled water at appropriate pH and solid contents followed by wet milling to PSD in the D₉₀ range of 15-25 microns.

Ceramic honeycomb flowthrough substrates (4.66×3″, 400/3) were coated using the Cu-zeolite slurry (inlet 50%) and the PGM-containing slurry (outlet 50%), dried (120-180° C.) and calcined (400-600° C.) in air, respectively. The total wash coat amount is 2.5-3.5 g/in³.

### Catalyst Performance Evaluation

Catalysts described above were wash-coated on appropriate substrates as described above. The close-coupled can (CC) is such that the three-way catalyst (TWC) coated on a flowthrough substrate and the four-way catalyst (FWC) coated on a wall-flow substrate are placed in the same canning with the TWC closer to the engine. This can is used upstream for the different downstream components, respectively (see system layouts).

The components evaluated were aged in an oven unit fitted with gas dosing possibilities and flow meters and thermocouples at the inlet and interior sections, respectively. The gas composition within the oven is 5% oxygen and 10% water (rest N2) at oven interior temperature of 820° C. for 15 hours. All the different components were placed in the same oven and exposed to the same air mass flows at the same temperature.

The system and consequently component evaluation (WLTC) were carried out on a Euro 6 GTDI vehicle using a chassis dyno test cell. The latter is fitted with thermoelements and FT-IR units at the engine out/catalyst inlet, catalyst bed and outlet positions, allowing for accurate recording of temperatures and gaseous emissions along the exhaust line.

1-15. (canceled)

16. An exhaust gas treatment system for reducing ammonia emission from a gasoline engine comprising a three-way conversion catalyst (TWC) and a gasoline particulate filter (GPF) further comprising a catalytic function for reducing tailpipe emission of ammonia characterized in that the catalytic function for reducing tailpipe emission of ammonia includes at least a combination of a selective catalytic reduction catalyst (SCR) and an ammonia oxidation catalyst (AMOx).

17. The exhaust gas treatment system according to claim 16 comprising a first three-way conversion catalyst (TWC) followed by a gasoline particulate filter (GPF) coated with a second three-way conversion catalyst (TWC).

18. The exhaust gas treatment system according to claim 16, wherein the three-way conversion catalyst and the gasoline particulate filter (GPF) are positioned upstream of the exhaust gas treatment system in close-coupled (CC) position to the gasoline engine.

19. The exhaust gas treatment system according to claim 16, wherein the selective catalytic reduction catalyst (SCR) and the ammonia oxidation catalyst (AMOx) are combined on a substrate in one single layer.

20. The exhaust gas treatment system according to claim 16, wherein the ammonia oxidation catalyst (AMOx) comprises at least one catalytic metal on an alumina substrate.

21. The exhaust gas treatment system according to claim 16, wherein the ammonia oxidation catalyst (AMOx) comprises at least rhodium on a zirconia-doped alumina support, preferably rhodium in combination with platinum and/or palladium on an alumina support.

22. The exhaust gas treatment system according to claim 16, wherein the ammonia oxidation catalyst (AMOx) does not comprise any rhodium.

23. The exhaust gas treatment system according to claim 16, wherein the ammonia oxidation catalyst (AMOx) comprises titanium and/or manganese, preferably in combination with platinum and/or palladium, on an alumina support.

24. The exhaust gas treatment system according to claim 16, wherein the selective catalytic reduction catalyst (SCR) comprises a metal-promoted, preferably copper-or iron-promoted zeolite, preferably a copper-or iron-promoted chabazite zeolite.

25. The exhaust gas treatment system according to claim 16, wherein the catalytic function for reducing tailpipe emission of ammonia including at least a combination of a selective catalytic reduction catalyst (SCR) and an ammonia oxidation catalyst (AMOx), the ammonia oxidation catalyst (AMOx) comprising a three-way conversion catalyst (TWC) including at least one platinum group metal, an oxygen storage component (OSC), preferably comprising ceria-zirconia, and optionally a promoter, preferably comprising baria.

26. The exhaust gas treatment system according to claim 16, wherein the catalytic function for reducing tailpipe emission of ammonia including at least the combination of the selective catalytic reduction catalyst (SCR) and the ammonia oxidation catalyst (AM Ox) is a zoned catalytic function defined by the selective catalytic reduction catalyst (SCR) comprising the metal-promoted zeolite being washcoated at the inlet zone of the catalytic function for reducing tailpipe emission of ammonia, and the ammonia oxidation catalyst (AMOx), preferably comprising a three-way conversion (TWC) catalyst, being washcoated at the outlet zone of the catalytic function for reducing tailpipe emission of ammonia.

27. The exhaust gas treatment system according to claim 20, wherein the catalytic function for reducing tailpipe emission of ammonia including at least the combination of the selective catalytic reduction catalyst (SCR) and the ammonia oxidation catalyst (AM Ox) is a zoned catalytic function defined by the selective catalytic reduction catalyst (SCR) comprising the metal-promoted zeolite being washcoated at the inlet zone of the catalytic function for reducing tailpipe emission of ammonia, and the ammonia oxidation catalyst (AMOx), preferably comprising a three-way conversion (TWC) catalyst, being washcoated at the outlet zone of the catalytic function for reducing tailpipe emission of ammonia.

28. The exhaust gas treatment system according to claim 16 is further configured with one or more of:
a first three-way conversion catalyst (TWC) followed by a gasoline particulate filter (GPF) coated with a second three-way conversion catalyst (TWC); or,
the three-way conversion catalyst and the gasoline particulate filter (GPF) are positioned upstream of the exhaust gas treatment system in close-coupled (CC) position to the gasoline engine;
wherein the catalytic function for reducing tailpipe emission of ammonia including at least the combination of the selective catalytic reduction catalyst (SCR) and the ammonia oxidation catalyst (AM Ox) is a zoned catalytic function defined by the selective catalytic reduction catalyst (SCR) comprising the metal-promoted zeolite being washcoated at the inlet zone of the catalytic function for reducing tailpipe emission of ammonia, and the ammonia oxidation catalyst (AMOx), preferably comprising a three-way conversion (TWC) catalyst, being washcoated at the outlet zone of the catalytic function for reducing tailpipe emission of ammonia.

29. The exhaust gas treatment system according to claim 26, wherein the washcoat comprising the ammonia oxidation catalyst (AMOx), preferably comprising the additional three-way conversion catalyst (TWC), is prepared from a slurry comprising the at least one platinum group metal on a support without the step of thermally fixating the platinum group metal on the support.

30. A method for the preparation of the exhaust gas treatment system according to claim 20, the method comprising the steps of:
providing a three-way conversion catalyst (TWC) and a gasoline particulate filter (GPF);
preparing a first slurry comprising the ammonia oxidation catalyst (AMOx) by impregnating at least one catalytically active metal on an alumina support;
preparing a second slurry comprising the selective catalytic reduction catalyst (SCR) comprising a metal-promoted zeolite;
blending the first slurry and the second slurry to obtain a combined slurry comprising the ammonia oxidation catalyst (AMOx) from the first slurry and the selective catalytic reduction catalyst (SCR) from the second slurry;
impregnating a support with the combined slurry to obtain the catalytic function for reducing the tailpipe emission of ammonia comprising the ammonia oxidation catalyst (AMOx) and the selective catalytic reduction catalyst (SCR) combined in a single layer on the support; and,
positioning the catalytic function for reducing the tailpipe emission of ammonia comprising the ammonia oxidation catalyst (AMOx) and the selective catalytic reduction catalyst (SCR) downstream to the three-way conversion catalyst (TWC) and the gasoline particulate filter (GPF).

31. The method according to claim 30, wherein the second slurry comprising the selective catalytic reduction catalyst (SCR) is prepared by providing a slurry comprising a zeolite, which is not metal-promoted or metal-promoted, and carrying out metal exchange of the zeolite by ion exchange in the slurry to obtain the second slurry comprising the selective catalytic reduction catalyst (SCR) comprising the metal-promoted zeolite.

32. A method of treating an exhaust gas stream from a gasoline engine comprising the steps of providing an exhaust gas stream from a gasoline engine comprising ammonia, and contacting the exhaust gas stream comprising ammonia with the exhaust gas treatment system according to claim 16 to reduce the ammonia emission in the exhaust gas stream at the tailpipe.
